(19) United States
(12) Patent Application Publication
(10) Pub. No.: US 2008/0033853 A1
(43) Pub. Date: Feb. 7, 2008

(54) SYSTEM AND METHOD FOR FACILITATING APPRAISALS

(75) Inventors: Bruce Beam, Arlington, VA (US); Richard Wilz, Charlotte, NC (US)

Correspondence Address: BANNER & WITCOFF, LTD., 1100 13th STREET, N.W., SUITE 1200, WASHINGTON, DC, 20005-4051, US

(73) Assignee: WEB-APPRAISAL.COM, LLC, Arlington, VA (US)

(21) Appl. No.: 11/689,910

(22) Filed: Mar. 22, 2007

Related U.S. Application Data
(63) Continuation of application No. 09/756,682, filed on Jan. 10, 2001, now abandoned.
(60) Provisional application No. 60/194,595, filed on Apr. 5, 2000.

(51) Int. Cl. G06Q 40/00

(52) U.S. Cl. 705/35

(57) ABSTRACT

A system and method for facilitating appraisals is disclosed. A lender and/or customer may request an appraisal from a hub. The hub checks the schedules of local appraisers, selects an appraiser and schedules the appraisal. Once the appraisal has been completed, the appraiser uploads the appraisal information and the hub transfers the information to the requester or other customer. The hub may also store the appraisal and information about the uploaded appraisal for analysis regarding the appraised property or the appraiser's work product.

### 1 BACKGROUND

1. Technical Field

The invention generally relates to financial processing. More particularly, the invention relates to requesting and fulfilling property appraisals over a network.

2. Related Art

Conducting financial transactions over the Internet has become commonplace. Investors buy and sell stocks, consumers purchase goods from web sites, and the like. From the selection of the goods, to the purchasing of the goods, to the delivery method, these can be selected on-line. In this regard, a number of retailers of goods have migrated wholly or in part to the sale of goods over the Internet. However, the Internet has not as readily supplanted the service industry. Reasons for the service industry facing a greater barrier to migrating to the Internet include the need for scheduling a selected service, the need for selecting the specific service provider, the need ensuring that the service was performed, and other related issues. While cost savings may exist for members of the service industry if they were able to migrate to the Internet, overcoming the impediments mentioned above prevents entry into the electronic marketplace.

For example, the real estate appraisal industry is labor intensive. In general, a representative of a lender (generally a bank employee) telephones an appraiser and schedules an appraisal for a house. The appraiser appraises the house, fills out appraisal forms, and mails the forms to the lender. The problem with this arrangement is the number of delays associated with finding an appraiser, scheduling the appraisal, mailing the forms back to the lender and the like, which do not relate to the performance of the underlying appraisal itself. Further, appraisals for mortgage loans required hard copies as a follow-up even if the original transmission of the appraisal was electronic. This requirement for hardcopies as the result of a binding contract between the appraiser and the lender added to delays as the hard copies would need to be mailed then later matched with the electronic version at the lender. In short, the appraisal contract was not considered satisfied until the hard copy of the appraisal was received. Accordingly, a need exists to streamline the appraisal requesting and fulfillment process.

Others have attempted to provide an electronic solution to the appraisal process with an EDI solution including REALEC Inc., Primis Inc., United Systems Software Co., The EDI Appraisal Network, FNC, Inc. and realink.com. Each of these appraisal management companies has adopted Fannie Mae's X-12 EDI format for the ordering and delivery of appraisal reports (“Appraisal Network Picks EDI Format”, National Mortgage News, Nov. 8, 1999, p. 8). This format allows the transmission of documents in an electronic form, but does not provide access to the individual pieces of information in the document itself. Therefore, while it does speed the process of moving this information around relative to paper, the workflow remains unchanged by forcing the lenders through the process of data entry of the received appraisals.

Further, lenders generally do not know the appraisers conducting an appraisal. The knowledge needed by lenders to select an appraiser generally comes from bad experiences with previous appraisers or appraisals. Accordingly, a system is needed that permits a lender to select an appraiser based on something other than past experience.

### 2. SUMMARY

The present invention provides a system and method for scheduling and receiving appraisals for real property. The present invention permits lenders to request appraisals electronically (through using, for example, a browser or email client) and to receive the completed appraisals in electronic form. In addition, lenders are able to select the appraiser based on various criteria (timeliness of appraisals, thoroughness of appraisals, and the like). The appraiser receives the appraisal requests, accepts or declines the appraisal assignment based on various criteria including scheduling conflicts, lender used, location of the home, and the like. Finally, after completing the appraisal, the appraiser uploads the completed appraisal documents for transmission to the requesting lender or lenders.

The system includes a lender or customer, an appraiser, and a grouping of systems coordinating the generating of the appraisal request to the appraiser and forwarding of his results to the requesting lender or customer. For purposes herein, the grouping of systems is collectively referred to as a “hub”. The request or requests may take a variety of forms including XML formatted data and comment delimited data.

In one embodiment, the lender's computer system includes an embedded adapter enabling the system to export the request for an appraisal. Alternatively, the lender's computer system may export a request to an application server, which forwards the request for the appraisal to the appraiser. In another embodiment, batch requests may be accepted. The batch requests may be transmitted by FTP file transfers. Further, the system permits the use of APIs to permit integration with third party systems.

These and other novel advantages, details, embodiments, features and objects of the present invention will be apparent to those skilled in the art from following the detailed description of the invention, the attached claims and accompanying drawings, listed herein, which are useful in explaining the invention.

### 3. BRIEF DESCRIPTION OF DRAWINGS

FIG. 1 shows a server-side system for providing appraisal information in accordance with embodiments of the present invention.

FIG. 2 shows a first embodiment of a computers exchanging information with the server-side system.

FIG. 3 shows a first embodiment of a computers exchanging information with the server-side system.

FIG. 4 shows a second embodiment of a computers exchanging information with the server-side system.

FIG. 5 shows a first embodiment of a computers exchanging information with the server-side system.

FIG. 6 shows a process for exchanging information in accordance with embodiments of the present invention

FIG. 7 shows a system for exchanging information between a requester, a hub, and an appraiser in accordance with embodiments of the present invention

FIG. 8 shows an alternative system for exchanging information between a requester, a hub, and an appraiser in accordance with embodiments of the present invention

### 4. DETAILED DESCRIPTION

The present invention relates to a system and method for requesting and receiving loan appraisals. While described in relation to the Internet, it is appreciated that all communication pathways may include dedicated networks and other communication systems including wireless paging, telephony, and digital information systems (for example, but not limited to, PCS).

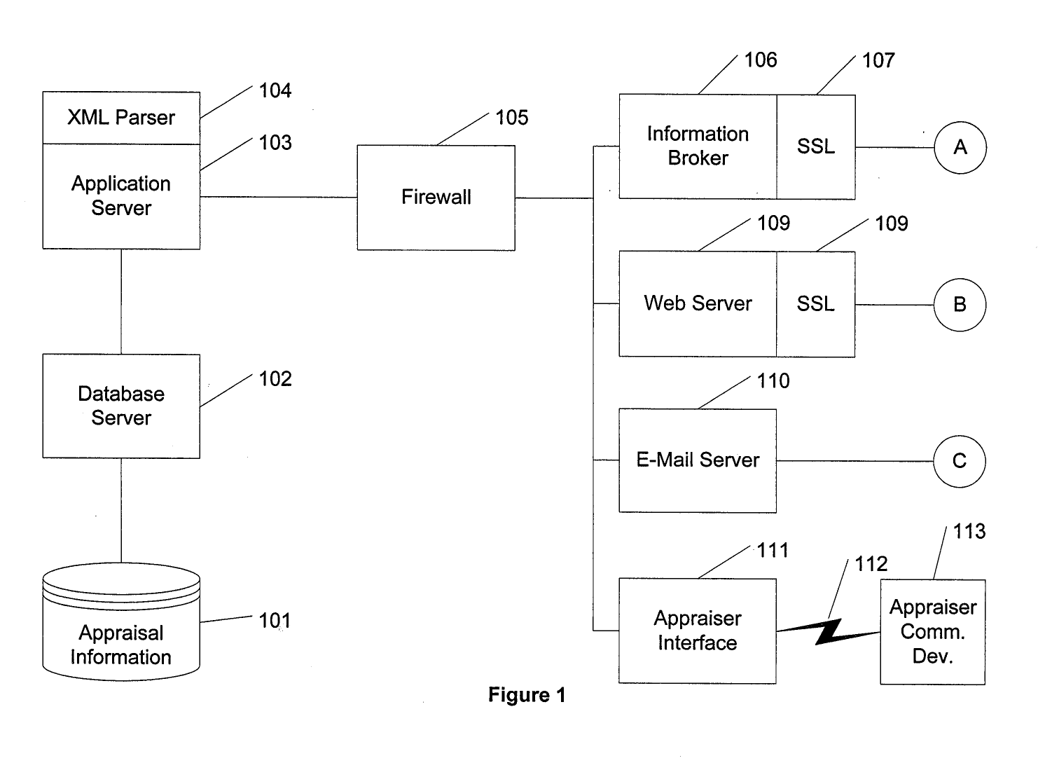

FIG. 1 shows a server-side system for coordinating the exchange of appraisal information. For simplicity, the server-side system is referred to herein as a “hub.” Appraisal information is stored in database 101. The appraisal information is accessed by a database server 102. The information is passed to application server 103, which includes XML parser 104. The information from the application server is transmitted through firewall 105 to various forwarding systems including an information broker 106, a web server 108, and an e-mail server 110. The information may be tagged as is known in the art to be transmitted via one of the forwarding systems to external entities. In one embodiment, the information broker 106 and web server 108 may receive and transmit information to external entities (represented as nodes A and B) without additional protection. However, in an alternate embodiment, the information broker 106 and the web server 109 both may include an SSL interface (107 and 109, respectively) to enhance security. Finally, information from application server 103 may be directed to e-mail server 110 to generate and forward e-mail to the external entities via node C.

Appraiser interface 111 is a direct conduit to an appraiser. For example, nodes A, B, and C may be located on the Internet or other network (including satellite network). Appraiser interface 111 reflects a conduit to an appraiser not using the Internet (for example, a non-Internet based, non-satellite telephone or pager). Appraiser communication device 113 receives information directly from the appraiser interface device 111 over pathway 112.

In one embodiment, the application server 103 exchanges information with external entities (including appraisers, lenders, customers, and others) with minimal modification of the information. Alternatively, XML parser 104 parses the information from database 101, encodes it in XML, and forward the encoded information to the external entities. By using XML, the external entities may have purpose-built devices that decode the XML encoded information and use it as needed. XML standards, their authors, and the applicable industry sector are found at http://www.xml.org/xmlorg_registry/index.shtml. The attached appendix lists industry sectors and XML authors. When using XML, XML is the format of transmitted data. XML is a way of formatting data into predefined entities that makes it easy to share the data among applications. Developers may create Document Type Definitions (DTDs) that specify what the required data elements are for a particular type of XML document. The following DTDs may be used including:
1. Header (on every transaction with from/to information)
2. Appraisal Request
3. Appraisal Response
4. Confirm receipt (or request or response)
5. Signature
6. Error

The appraisal response may take various formats based on forms used for different appraisals. Also, the electronic signature may be sent with each communication and used to authenticate the transmission and related data.

Likewise, the external entities may upload information in various forms. The appraiser uploads the completed appraisal to the hub. The completed appraisal may take the form of freeform text, text added to a form, XML text, photographs or drawings, and any combination thereof. In the example, where XML is used to mark up entries being uploaded to database 101, the XML parser 104 receives the marked-up information and provides the corresponding information for storage in database 101.

Using the above system, the information stored in the database may be used in a variety of ways. First, as the appraisal process no longer requires paper, the database 101 becomes a repository for the completed appraisal. The appraisal may be archived and kept in accordance with document retention policies. Second, a lender may retrieve appraisals for comparable houses in a similar area for an appraiser prior to the appraiser going to do the appraisal. These comps may also be used to compare the appraisal against other appraisals to see if the appraisal falls within a range of the previous appraisals (or slightly above or below). This comparison helps maintain the accuracy of the appraisal. Third, the data may be fed into automated valuation models. Finally, the data may be used to create performance statistics for appraisers, which lenders may use as selection criteria.

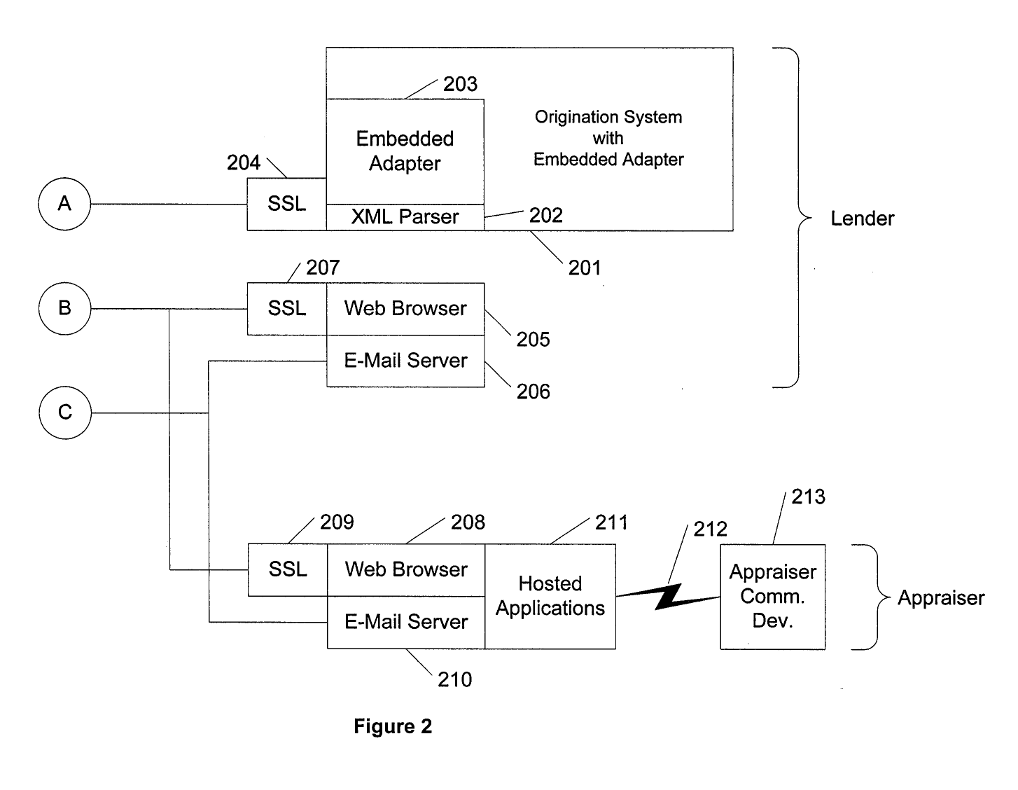

FIG. 2 shows a first embodiment of external clients as connected to nodes A, B, and C. A lender includes a computer application (referred to as an origination system) 201 with an embedded adapter 203 for transmitting information to the hub. The computer application 201 is associated with the lender. In this embodiment, the lender enters loan information into the computer application 201 including address information and a requested date for delivery of the appraisal. The computer application 201 generates a request for an appraisal and transmits it to the hub using the embedded adaptor 203. The embedded adaptor 203 extracts the appropriate information from the entered information in computer application 201 as well as other information (for example, the email address of the lender, if needed) and packages the information for transmission to the hub. If needed, an XML parser 202 adds XML information to the request generated by the embedded adaptor 203. Also, an SSL interface 204 may also be added to the computer application to further authenticate the lender.

The SSL interface may be used in combination with or replaced by SET and Kerberos interfaces. Kerberos is an authentication and encryption scheme that allows a user to become “known” by an authenticating server and then use that authentication to access systems and services on the Internet. The services may then transpire in an encrypted fashion to further secure transactions occurring over the net (e.g. with SSL or SET).

SSL uses public and private encryption keys to provide privacy between two communicating applications and authenticates the server and (optionally) the client. The protocol begins with a handshake phase. During this phase, SSL negotiates an encryption algorithm and symmetric session keys before using certified asymmetric public keys to authenticate a server to the client. After the handshake, transmission of application data begins. SSL uses the session keys negotiated during the handshake to encrypt data.

The SET protocol, designed for credit-card transactions, supports the full life cycle of the transaction and is divided into the following categories:

| | |
|---|---|
| Authorization: | At the time of purchase, the card is checked to ensure |
| | that it is valid and that the cardholder is within |
| | purchasing limits. |
| Capture: | Transactions are placed into a clearance batch. |
| Voiding: | A bad transaction or other denial is canceled. |
| Clearance: | The cardholder is billed on the usual monthly statement. |
| Refund: | A transaction is voided, and money is refunded. |
| Settlement: | Money is moved between banks using the existing card- |
| | processing network. |

The lender may use the hub through APIs enabled by the hub. Further, the APIs may be combined with third party systems including, but not limited to, the following:
A La Mode, Inc., providing appraisal-related information and services including appraiser listings, technology/EDI updates, and software information;
ACI Development, providing software solutions, including electronic forms, digital imaging, and communications software, for the real estate appraisal, home inspection, and insurance industries;
Apex Professional Graphics Systems;
Appraiser's ToolBox, providing Windows (from the Microsoft Corporation) and Mac (from the Apple Computer, Inc.) form processing software with integrated tools;
CSA, Inc., providing Canadian appraisal forms (including the CERC) and CRAL software;
Day One, Inc., providing a office management systems and appraisal forms software;
Eminent Domain Software, providing real estate software for appraisers, inspectors and tax assessors;
MBR2 Software, providing, Appraiser's Photo Assistant for Real Estate;
MicroSolve, providing offering software for local governments to assess property values and maintain property databases;
PSAR Systems, providing residential appraisal software; and
United Systems Software Company, providing appraisal software, electronic forms solutions, EDI, and artificial intelligence.

The lender of FIG. 2 may also have a separate contact pathway with the hub. The alterative pathway includes a web browser 205 and/or an email server 206. The email server 206 is shown as a server for coordinating multiple email clients. Alternatively, the email server 206 may simply be an email client (Eudora™, Outlook™, and Outlook Express™) as is known in the art. If needed, an SSL interface 207 may be used. Using web browser 205, a lender accesses a page with forms for submitting a request for an appraisal and sends it to the hub through node B. Using email client 206, a user may enter appraisal information into an email free form, or may populate a predefined form with spaces for the various data. The email client 206 next transmits the request for an appraisal through node B back to the hub for processing. Information from the hub may be received back through this conduit including node C.

It is appreciated that the web browser 205 and email client 206 are shown as terminating applications. However, it is readily appreciated that the web browser 205 and email client 206 may also include a local web server and email server supporting multiple clients.

The appraiser may include a variety of ways of receiving and transmitting information with the hub. The appraiser may have a web browser 208 and view an on-line web page having his current schedule of appraisals and their status. To enhance security, the web browser 208 may also use SSL 209. Also, the appraiser may use an email server 210 (or an email client) to receive requests for appraisals or scheduling orders and to upload completed appraisals (or in the case of not being able to complete an appraisal, uploading notification of the inability to complete the appraisal). Web browser 208 and email server 210 may be standalone applications are as known in the art. Alternatively, the appraiser may use host applications 211 that communicate with the web browser 208 or email server 210

The lender or other individual may access a web site to obtain various information regarding the appraisal. For example, the web page may including the following fields as populated from database 101.

| | |
|---|---|
| Status | Shows a list of all pending requests and responses, also |
| | a page where the system may display broadcast messages |
| | to the user |
| Request | User may view the details of a particular request, and |
| Detail | accept, reject, or respond to the request |
| Response | User enters in information based on the type of appraisal |
| | requested. This is also where the user can upload digital |
| | photos in .jpg format |
| Adminis- | User can carry out following functions: reporting, account |
| tration | information, update company contact information, change |
| | password, etc. |

Other host applications would communicate directly with the information broker 106, without user the web browser 208 or email server 210. The hosted applications 211 may provide the information directly to the appraiser. Alternatively, the hosted applications 211 may transmit information wirelessly 212 to the appraiser's communication device 213. The communication device may be a pager or a PCS or web-enabled phone. Other equivalent devices include handheld devices capable of wirelessly transmitting and receiving data.

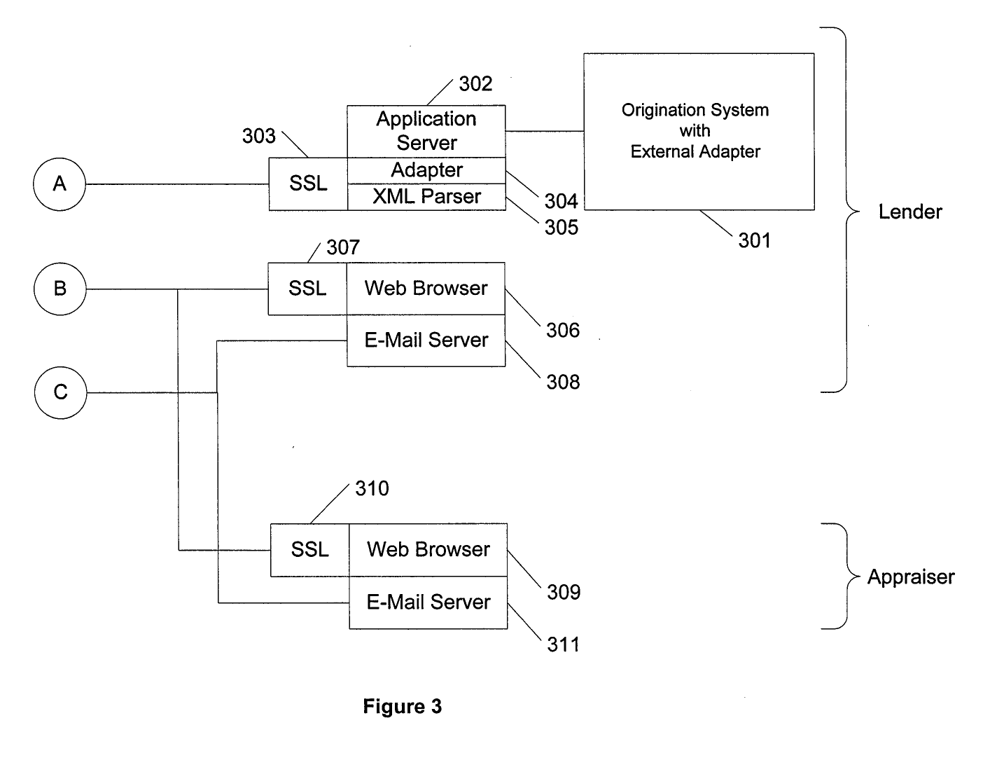

FIG. 3 shows a system similar to that of FIG. 2. The lender includes an origination system with an external adapter 301 that connects to an application server 302. The application server 302 uses its own adapter 304 to communicate with the hub through node A. Also, the adapter 304 may wrap a request in XML via XML parser 305. The XML parser 305 both formats information into an XML format and extracts information from XML formatted information. The remaining aspects of lender (web browser 306, email server 308, and SSL connection 307) and appraiser (web browser 309, email server 311, and SSL connection 310) are the same as those disclosed in FIG. 2.

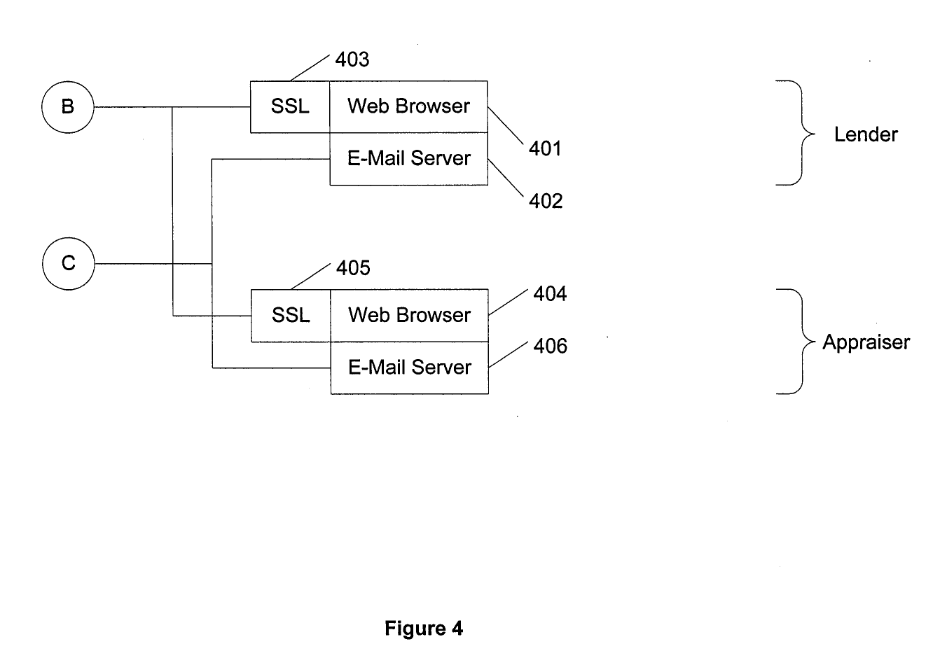

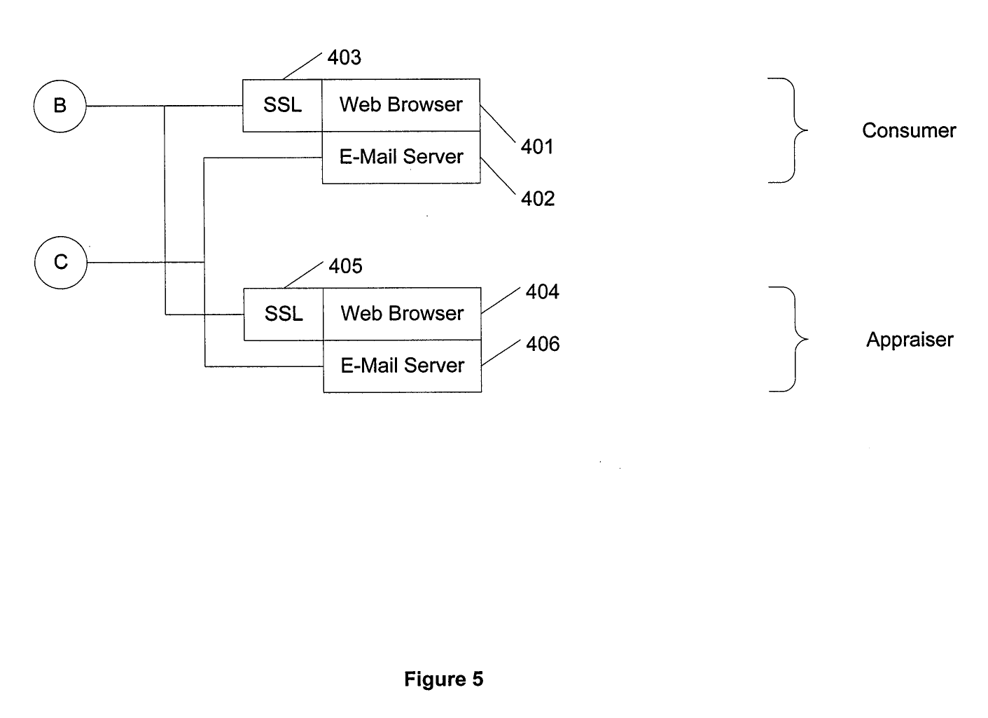

FIG. 4 shows a lender and appraiser similar to those shown above in FIGS. 2 and 3. However, here the lender only has access to a web-browser 401 and/or email server 402. The system also may include SSL connection 403. FIG. 5 shows a system similar to that of FIGS. 2-4 but includes a consumer with a web-browser 501 (with SSL 503) and/or email server 502

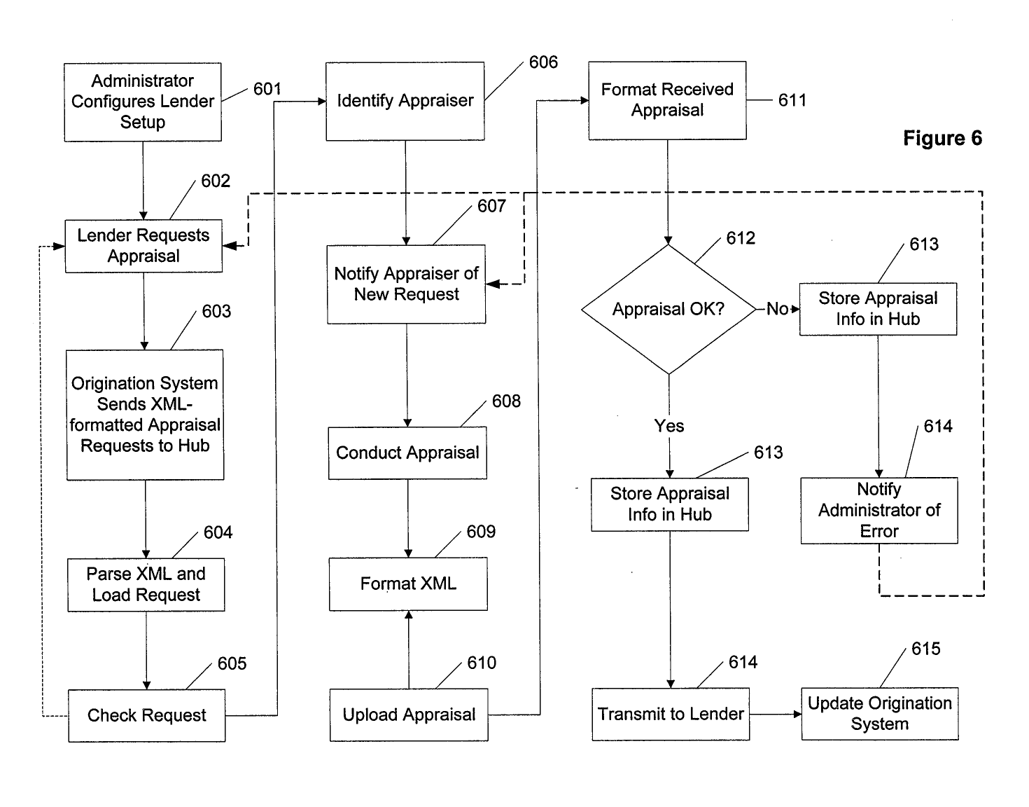

FIG. 6 shows a process for requesting and receiving appraisals. In step 601, an administrator configures a lender to have proper rights to the hub (referred to as “configure lender setup”). Next, once the lender has rights to access the hub, the lender requests an appraisal 602. When an lender requests an appraisal, the lender inputs information regarding the real property to be appraised, the date the appraisal is needed by, and other criteria that permits the hub to select the appraiser and schedule the appraisal. Alternatively, the lender may select an appraiser directly. The lender's system (origination system, for example) sends appraisal request to the hub 603. The appraisal request may take the form of an XML request.

The hub parses the request (if in XML, and parses the XML data) and loads the request for processing (step 604). The hub then checks the request (step 605) to see if the request includes all needed information or that all needed information is available (for example, information previously stored relating to the lender or appraiser or predefined selection criteria). It is appreciated that the checking step 605 may be eliminated if desired or placed in a different location in the process or used a number of times throughout the process. If an error arises (or more information is needed, the hub alerts the lender to resend the request or to complete the missing or incorrect information.

Once the appraisal request is complete, the hub attempts to identify an appraiser based on the supplied criterion or criteria from the lender (or customer) in step 606. This step may also include checking the identified appraiser's schedule if stored with the hub (or otherwise accessible). The hub then notifies the appraiser of the new request in step 607. Once the appraisal has been scheduled, the hub alerts the lender. Also, if there is difficulty encountered in scheduling the appraisal, the hub alerts the lender to this effect. In this case, the lender may then change the appraisal request. For example, the lender may request a new appraiser, change the due date of the appraisal, and the like.

The appraiser conducts the appraisal (step 608) and forwards the appraisal to the hub. In the embodiments where the appraiser has electronic access or stored the appraisal electronically, the appraiser's communication device may format the appraisal (step 609) for easier processing. Next, the appraiser uploads the completed appraisal (step 610).

The hub formats the received appraisal in step 611 to be in a form for checking. The use of XML (or equivalent mark up language) may eliminate this step. Next, the hub checks the appraisal in step 612 to be sure that it conforms with the requested appraisal (for example, ensuring the correct house was appraised). The hub may also compare the appraisal with other appraisals of similarly situated properties to be sure that the appraisal is within a justifiable range. If the appraisal is ok, then the hub stores the appraisal for future reference (step 613) and transmits an electronic version of the appraisal to the lender or customer (in step 614). Finally, the originating system of the lender (or other system of the lender or customer) is updated with the appraisal 614, permitting access to the appraisal and the like.

If the appraisal is not ok as determined by step 612, the system stores the defective appraisal (or a portion or indication of the error) in step 613 and notifies an administrator of the hub of the error (in step 614). The notification of the administrator may be eliminated to facilitate faster handling of the appraisal. Next, if the error can be corrected by the appraiser, the hub notifies the appraiser of a request (back to step 607) to schedule the correction of the appraisal. If the error exists with the appraisal request or not for the fault of the appraiser (for example, the house to be appraised burned down, the appraiser was unable to complete the appraisal for circumstances beyond his control, or the appraisal would be inaccurate for some reason), then the hub alerts the lender to re-request the appraisal (back to step 602). Alternatively, the hub provides the lender with the ability to select another appraiser or change the criterion or criteria used to select the appraiser.

In one embodiment, the hub primarily acts as a conduit in transmitting received appraisal requests to an appraiser and receives acknowledgement that the appraisal request including scheduled time has been accepted. This approach minimizes the processing time consumed by the hub. Alternatively, the appraiser may store his appraisal schedule with the hub and have the hub coordinate whether the appraiser has time to conduct an appraisal by the lender's requested due date and time. In this alternative approach, the hub may commit the appraiser to an appraisal without confirmation by the appraiser. Also, the hub may again request confirmation of the scheduled appraisal from the appraiser prior to committing the appraiser to the requested appraisal.

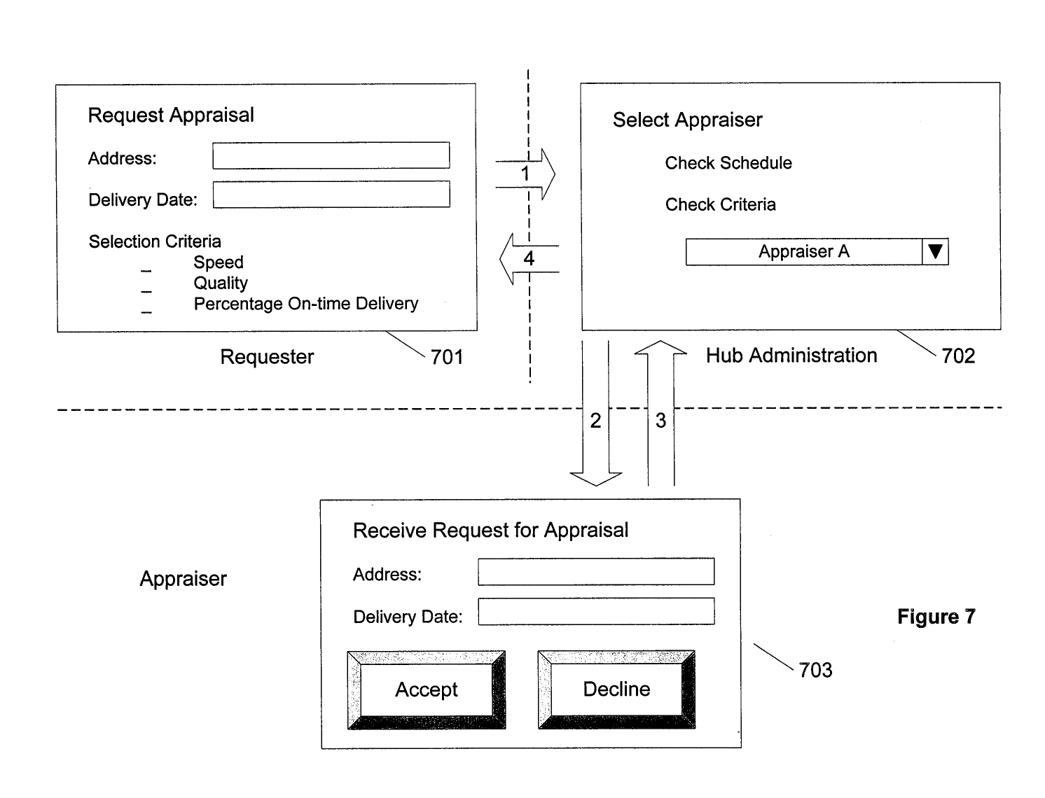

FIG. 7 shows a system for scheduling an appraisal with an appraiser. The requestor populates a user interface 701 displayed on a computer screen. The appraisal request includes the address for the appraisal, the expected delivery date of the appraisal, and at least one criterion for selecting the appraiser (speed, quality, percentage on-time delivery, and the like). While not shown, the requester may also specify a specific appraiser or appraising company.

The request is then sent (as shown by arrow 1) to the hub when the hub administration (a person or predefined software program) checks the submitted criterion or criteria and selects an appraiser The appraiser is then notified of the new request for an appraisal (as shown in arrow 2). If the appraiser stores his schedule with the hub, then the hub may also check the stored schedule.

The appraiser (via device 703) receives the appraisal request and either accepts or declines the appraisal. The acceptance or rejection of the request is transmitted back to the hub as shown by arrow 3. Next, the requestor is notified of the acceptance or rejection of the request as shown by arrow 4. In an alternative embodiment, the hub recursively searches for a new appraiser if the first appraiser was unavailable or declined the appraisal request.

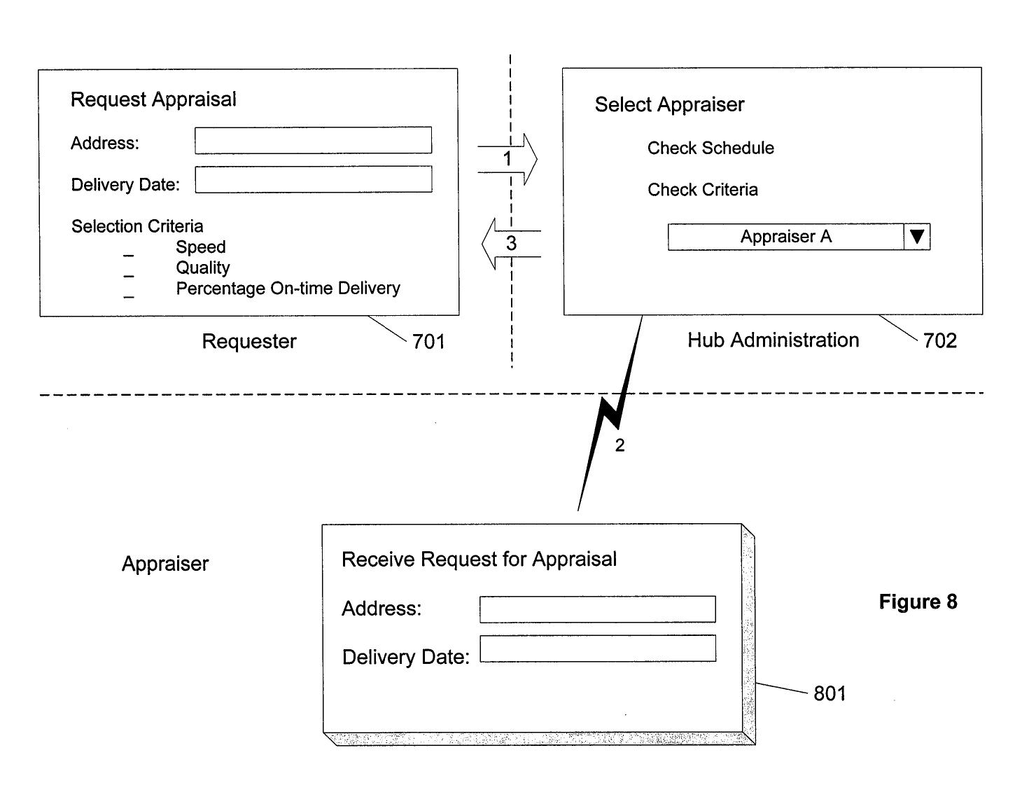

FIG. 8 shows a system for an alternate system for scheduling an appraisal with an appraiser. Here, the appraiser's communication device does not have acceptance/rejection functionality as compared to that of device 703. Here, the hub transmits the request to the appraiser with the expectation that the appraiser will complete the appraisal in due course. In this alternative embodiment, the request may include a call back number so the appraiser may contact the hub if unable to complete the appraisal by the specified time.

In the foregoing specification, the present invention has been described with reference to specific exemplary embodiments thereof. Although the invention has been described in terms of various embodiments, those skilled in the art will recognize that various modifications, embodiments or variations of the invention can be practiced within the spirit and scope of the invention as set forth in the appended claims. All are considered within the sphere, spirit, and scope of the invention. The specification and drawings are, therefore, to be regarded in an illustrative rather than restrictive sense. Accordingly, it is not intended that the invention be limited except as may be necessary in view of the appended claims.

We claim:

1. A computer-implemented method for facilitating an appraisal comprising the steps of:
receiving a request for an appraisal at a hub;
determining an appraiser to conduct said appraisal;
transmitting information related to said request for said appraisal to said appraiser;
receiving information relating to appraising work from said appraiser; and, transmitting a completed appraisal containing said information relating to said appraising work.

2. The computer-implemented method according to claim 1, wherein said information relating to said request contains XML information.

3. The computer-implemented method according to claim 1, wherein said information relating to said appraising work contains XML information.

4. The computer-implemented method according to claim 1, wherein said appraiser includes a communication device that permits acceptance or rejection of said request.
